(19) United States
(12) Patent Application Publication
(10) Pub. No.: US 2011/0301291 A1
(43) Pub. Date: Dec. 8, 2011

(54) OXAZOLINE AND/OR OXAZINE COMPOSITIONS

(76) Inventor: Puwei Liu, San Marcos, CA (US)

(21) Appl. No.: 13/211,439

(22) Filed: Aug. 17, 2011

Related U.S. Application Data
(63) Continuation of application No. PCT/US2010/023482, filed on Feb. 8, 2010.
(60) Provisional application No. 61/153,831, filed on Feb. 19, 2009.

(51) Int. Cl. C08L 79/04; C08K 3/36; C09D 179/04; C08G 73/06

(52) U.S. Cl. 524/612; 528/403; 528/408

(57) ABSTRACT

A curable composition comprising an oxazoline and/or an oxazine and a cationic cure initiator, in the absence of any phenolic compounds, is suitable for use as a molding or coating composition for semiconductor boards and devices.

### CROSS-REFERENCE TO RELATED APPLICATIONS

This application is a continuation of International Application No. PCT/US2010/023482 filed Feb. 8, 2010, which claims the benefit of U.S. Provisional Patent Application No. 61/153831 filed Feb. 19, 2009, the contents of both of which are incorporated herein by reference.

### BACKGROUND OF THE INVENTION

The present invention relates to an oxazoline and/or oxazine composition having an oxazoline and/or oxazine component and a cationic cure initiator in the absence of any phenolic compound.

Electronic devices such as circuit boards, semiconductors, transistors, and diodes are often coated with materials such as epoxy resins for protection. Such coating materials are often cured on the surface of an electronic device by heat using phenolic resins as a curing hardener. This presents several problems. Electronic devices often are sensitive to heat, and too much heat may adversely affect the performance of a device. If the coating material shrinks or expands significantly in response to heat, the device it coats may be warped. The presence of the phenolics introduces voids into the cured coating, which can lead ultimately to device failure. In addition, microelectronic packages and assemblies oftentimes use similar materials as encapsulants, such as underfill, or as adhesives, with the same attendant problems. Thus, it is desirable to develop materials that cure without phenolics at relatively low temperatures in short time periods and that have a near-zero volume change upon heat treatment so as to minimize the possibilities of damaging the end use device.

### SUMMARY OF THE INVENTION

This invention is a curable composition, suitable for molding or coating electronic devices or packages, comprising an oxazoline and/or an oxazine compound and a cationic cure initiator, in the absence of any phenolic compound or resin. An oxazoline compound is any monomer, oligomer, or polymer containing an oxazoline moiety, in which the oxazoline moiety is a five membered heteroxyclic ring having an imido ether linkage. An oxazine compound is any monomer, oligomer, or polymer containing an oxazine moiety, in which the oxazine moiety is a six membered heterocyclic ring having an imido ether linkage. The oxazoline and oxazine moieties have the structure

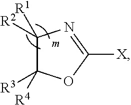

in which R¹, R², R³, R⁴, and X are hydrogen or a direct bond to a divalent organic radical, and m is 1 for oxazoline and 2 for oxazine.

An exemplary compound has the structure

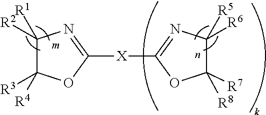

in which k is 0-6; m and n are each independently 1 or 2; X is a monovalent or polyvalent radical selected from branched chain alkyl, alkylene, alkylene oxide, ester, amide, carbamate and urethane species or linkages, having from about 12 to about 500 carbon atoms; and R¹ to R⁸ are each independently selected from C₁₋₄₀ alkyl, C₂₋₄₀ alkenyl, each of which being optionally substituted or interrupted by one or more —O—, —NH—, —S—, —CO—, —C(O)O—, —NHC(O)—, and C₆₋₂₀ aryl groups.

In another embodiment, this invention is a method of preparing a cured polyoxazoline and/or oxazine (PBO) composition comprising heating a composition comprising an oxazoline and/or an oxazine compound and a cationic cure initiator, in the absence of a phenolic compound (in which compound means any monomer, oligomer or polymer), to a temperature sufficient to cure the composition and thereby forming the cured PBO. In one embodiment the composition is heated to a temperature or a range of temperatures within the range of about 160° C. to about 240° C. for about two minutes to about four minutes. The method can be used, for example, to provide a coating on electronic devices such as circuit boards and semiconductors.

In another embodiment, the invention is a method of coating or molding a device comprising coating the device with a composition comprising an oxazoline and/or an oxazine compound and a cationic cure initiator, in the absence of any phenolic compound, and heating the composition to a temperature sufficient to cure the composition. In one embodiment the composition is heated to a temperature or a range of temperatures within the range of about 160° C. to about 240° C. for about two minutes to about four minutes. In particular embodiments, the device is an electronic device, such as, a semiconductor or a circuit board.

### DETAILED DESCRIPTION OF THE INVENTION

As used herein, the following terms apply:

Alkyl is a straight or branched hydrocarbon chain containing 1 to 8 carbon atoms. Examples of alkyl include, but are not limited to, methyl, ethyl, propyl, isopropyl, butyl, isobutyl, sec-butyl, tert-butyl, n-pentyl, and 2-methylhexyl.

Cycloalkyl is a cyclic alkyl group containing 3 to 8 carbon atoms. Some examples of cycloalkyl are cyclopropyl, cyclopentyl, cyclohexyl, cycloheptyl, adamantyl, and norbornyl. Heterocycloalkyl is a cycloalkyl group containing 1-3 heteroatoms such as nitrogen, oxygen, or sulfur. Examples of heterocycloalkyl include piperidinyl, piperazinyl, tetrahydropyranyl, tetrahydrofuryl, and morpholinyl.

Aryl is an aromatic group containing 6-12 ring atoms and can contain fused rings. Examples of an aryl group include phenyl, naphthyl, biphenyl, phenanthryl, and anthracyl. Heteroaryl is aryl containing 1-3 heteroatoms such as nitrogen, oxygen, or sulfur and can contain fused rings. Some examples of heteroaryl are pyridyl, furanyl, pyrrolyl, thienyl, thiazolyl, oxazolyl, imidazolyl, indolyl, benzofuranyl, and benzthiazolyl.

Amino groups can be unsubstituted, mono-substituted, or di-substituted, for example, with groups such as alkyl, cycloalkyl, heterocycloalkyl, aryl, heteroaryl, aralkyl, or heteroaralkyl.

Cyclic moiety refers to a 5- to 6-membered cycloalkyl, heterocycloalkyl, aryl, or heteroaryl moiety. A cyclic moiety can be fused rings formed from two or more of the just-mentioned groups. Each of these moieties is optionally substituted with alkyl, cycloalkyl, heterocycloalkyl, aryl, heteroaryl, aralkyl, heteroaralkyl, alkoxy, hydroxyl, hydroxylalkyl, carboxyl, halo, haloalkyl, amino, aminoalkyl, alkylcarbonyloxy, alkyloxycarbonyl, alkylcarbonyl, alkylcarbonylamino, aminocarbonyl, alkylsulfonylamino, aminosulfonyl, sulfonic acid, or alkylsulfonyl.

Halo refers to fluoro, chloro, bromo, or iodo.

A molding composition refers to a composition having an oxazoline and/or oxazine compound that can form a PBO polymer composition of this invention.

The compositions of this invention are deemed cured when they form a good cull cure; a cull cure is one that results in a polymer that is strong and not brittle.

Suitable oxazoline and/or oxazine compounds (monomers) can be prepared by condensing two equivalents of formaldehyde with one equivalent of a primary amine (e.g., methylamine and aniline) and reacting with one equivalent of a phenol (e.g., bisphenol-A). For reference, see, Burke et al., J. Org. Chem. 30(10), 3423 (1965). Substituent groups are not particularly limited and in addition to hydrogen, can be, for example, alkyl, cycloalkyl, heterocycloalkyl, aryl, heteroaryl, aralkyl, heteroaralkyl, alkoxy, hydroxyl, hydroxylalkyl, carboxyl, halo, haloalkyl, amino, aminoalkyl, alkylcarbonyloxy, alkyloxycarbonyl, alkylcarbonyl, alkylcarbonylamino, aminocarbonyl, alkylsulfonylamino, aminosulfonyl, sulfonic acid, or alkylsulfonyl. Bi-functional oxazoline and/or oxazine monomers (e.g., oxazoline and/or oxazine monomers prepared from bisphenol-A, formaldehyde, and aniline) can also be employed in the polymerization reaction.

The five membered oxazoline compounds are particularly suitable in that they have more ring strain than the six membered oxazine compounds. Suitable exemplary oxazolines include 4,4′,5,5′-tetrahydro-2,2′-bis-oxazole, 2,2′-bis(2-oxazoline); a 2,2′-(alkanediyl)bis[4,4-dihydrooxazole], e.g., 2,2′-(2,4-butanediyl)bis[4,5-dihydrooxazole] and 2,2′-(1,2-ethanediyl)bis[4,5-dihydrooxazole]; a 2,2′-(arylene)bis[4,5-dihydrooxazole]; e.g. 2,2′-(1,4-phenylene)bis(4,5-dihydrooxazole], 2,2′-(1,5-naphthalenyl)bis(4,5-dihydrooxazole], 2,2′-(1,3-phenylene)bis[4,5-dihydrooxazole), and 2,2′-(1,8-anthracenyl)bis[4,5-dihydrooxazole; a sulfonyl, oxy, thio or alkylene bis 2-(arylene)[4,5-dihydrooxazole, e. g. sulfonyl bis 2-(1,4-phenylene)[4,5-dihydrooxazole], thio bis 2,2′-(1,4-phenylene)[4,5-dihydrooxazole] and methylene bis 2,2′-(1,4-phenylene) [4,5-dihydrooxazole]; a 2,2′,2″-(1,3,5-arylene)tris[4,5-dihydrooxazole], e.g., 2,2′,2″-tris(4,5-dihydrooxazole]1,3,5-benzene; a poly[(2-alkenyl)4,5-hydrooxazole], e.g., poly[2-(2-propenyl)4,5-dihydrooxazole], and others and mixtures thereof.

In some embodiments, the oxazoline compounds will have the following structures.

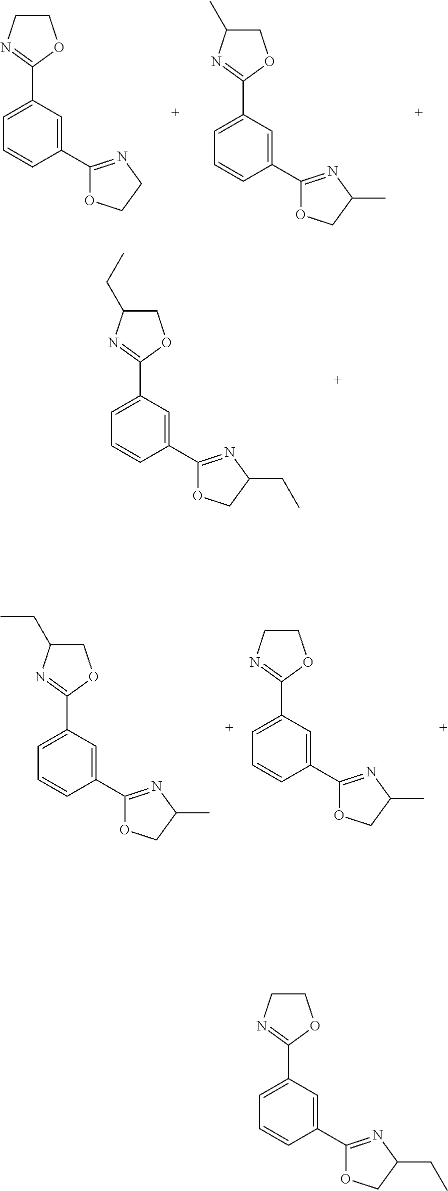

One, or two or more of these compounds, can be used in the compositions of this invention. The first structure 1,3 bisoxazoline is particularly useful in mold compound applications because it is a solid. A combination of all the above bisoxazolines forms a liquid composition, and is particularly useful where liquid materials are needed, such as in underfill applications.

The weight percent of the oxazoline and/or oxazine monomer present in the composition ranges from 5.0% to 20.0% by weight of the total composition. In one embodiment, the weight percent of the oxazoline and/or oxazine monomer present is from about 10.0% to about 15.0%.

Suitable cationic initiators include Lewis acids and other known cationic initiators. These include metal halides such as AlCl₃, AlBr₃, BF₃, SnCl₄, SbCl₄, ZnCl₂, TiCl₅, WCl₆, VCl₄, PCl₃, PF₅, SbCl₅, (C₆H₅)₃C⁺(SbCl₆)⁻, and PCl₅⁻; organometallic derivatives such as RAlCl₂, R₂AlCl, and R₃Al where R is a hydrocarbon and preferably an alkyl of 1 to 8 carbon atoms; metallophorphyrin compounds such as aluminum phthalocyanine chloride; methyl tosylate, methyl triflate, and triflic acid; and oxyhalides such as POCl₃, CrO₂Cl, SOCl, and VOCl₃. Other initiators include HClO₄ and H₂SO₄. The Lewis acid initiators are often used with a proton or cation donor such as water, alcohol, and organic acids. In one embodiment, the cationic initiator is methyl-p-toluenesulfonate.

The oxazoline and/or oxazine-containing compositions can be prepared by any conventional method, for example, the components can be finely ground, dry blended, densified on a hot differential roll mill, and then granulated. The composition can be used for coating electronic devices such as semiconductors or circuit boards. The prepared compositions can be molded by any suitable molding apparatus. An example of such an apparatus is a transfer press equipped with a multi-cavity mold. For more detail on methods for preparing molding compositions and for coating electronic devices, see U.S. Pat. No. 5,476,716.

In further embodiments, the curable composition may also contain an epoxy resin and a second acid catalyst.

Optionally, an epoxy resin can be added, and when present, a suitable epoxy resin is epoxy cresol novalac. The composition will contain, for example, about 0.5 wt % to about 7.0 wt %, preferably about 1.5 wt % to 3.5 wt %, of the epoxy resin.

Examples of other additives that can be included in the molding composition and the preferred ranges of their weight percent in the composition include: (1) a flame retardant such as a brominated epoxy novolac flame retardant (e.g., BREN, available from Nippon Kayaku, present in an amount up to 3.0 wt %, more preferably, 0.1-1.0 wt % of the total composition; (2) a flame retardant synergist such as Sb₂O₅ or WO₃, present in an amount up to 3.0 wt %, more preferably, 0.25-1.5 wt % of the total composition; (3) a filler, such as, silica, calcium silicate, and aluminum oxide, present in an amount of 70-90 wt %, more preferably, 75-85 wt % of the total composition; (4) a colorant such as carbon black, present in an amount of 0.1-2.0 wt %, more preferably, 0.1-1.0 wt % of the total composition; (5) a wax or a combination of waxes such as carnauba wax, paraffin wax, S-wax, and E-wax, present in an amount of 0.1-2.0 wt %, more preferably, 0.3-1.5 wt % of the total composition; (6) fumed silica, such as aerosil, present in amount of 0.3-5.0 wt %, more preferably, 0.7-3.0 wt % of the total composition; (7) a coupling agent, such as a silane type coupling agent, present in an amount of 0.1-2.0 wt %, more preferably, 0.3-1.0 wt % of the total composition.

The compositions cure in about 1 minute to 5 minutes; in one embodiment, they cure in about 2 minutes to 4 minutes.

### EXAMPLES

Voids were determined by visual observation.

Post cure volume shrinkage was measured according to the American Society for Testing and Materials standard test procedure ASTM D955-73.

### Example 1

Two compositions were prepared to contain the following bisoxazoline compounds in the molar ratio shown below the structures and either methyl-p-toluenesulfonate (MeOTs) at 3 weight percent, or a phenolic hardener (Rezicure 3700) at 40 weight percent, as the catalyst.

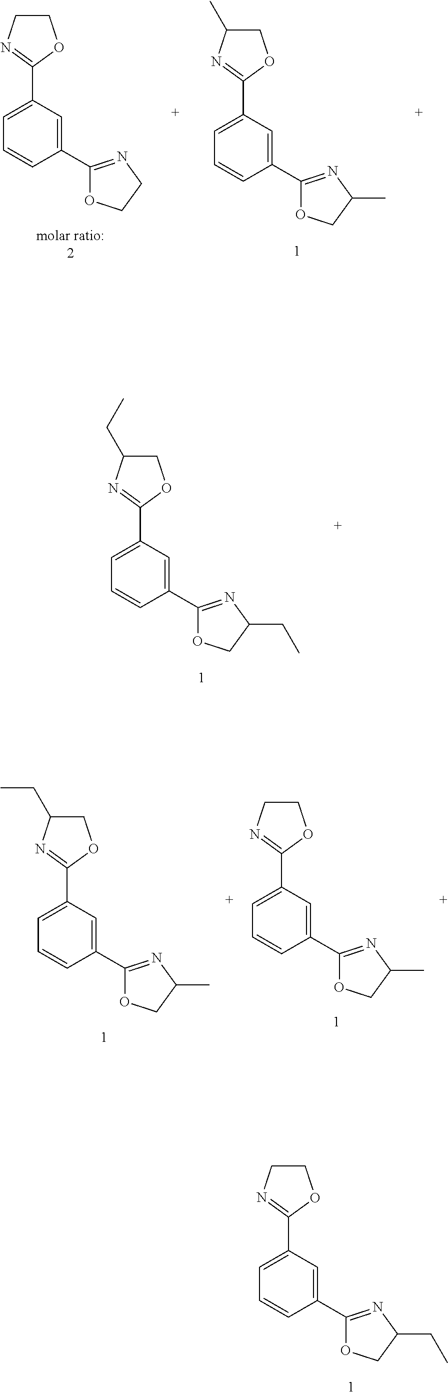

The compositions were tested for coefficient of thermal expansion, modulus (GPa), percent curing shrinkage, and the presence of voids. The results are tabulated in the following table and show that the composition without the phenolic hardener performed better in all tests.

| | CTE | Modulus | Curing | |
|---|---|---|---|---|
| | (ppm) | (Gpa) | shrinkage | Voids |
| Bisoxazoline mixture + | 37 | 3.8 | 0.2% | No |
| 3% MeOTs (cationic catalyst) | | | | |
| Bisoxazoline mixture + | 49 | 5.2 | 0.25% | Yes |
| 40% Phenolic hardener | | | | |
| (Rezicure 3700) | | | | |

### Example 2

A composition was prepared to contain 49% by weight of the same mixture of bisoxazoline compounds from example 1, 49% by weight of a mixture of benzoxazines, and 2% by weight of methyl-p-toluenesulfonate. The benzoxazines had the following structures and were present in the amounts shown below the structures:

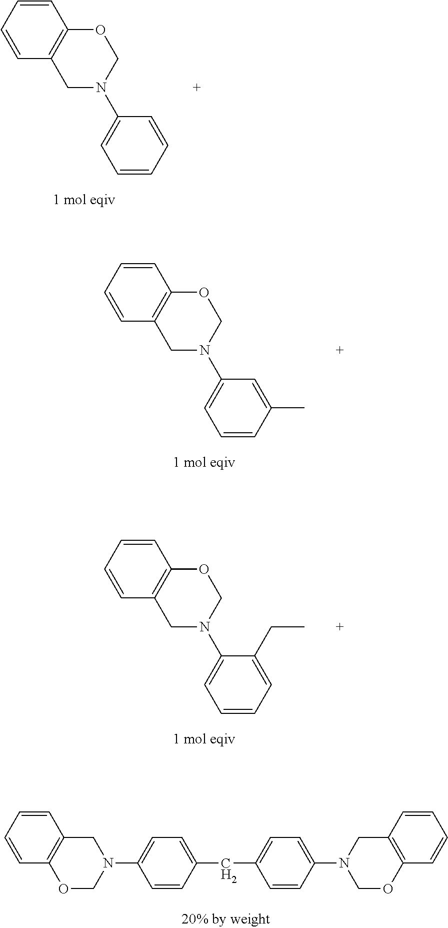

The samples were tested as for example 1. The results are tabulated in the following table and show the absence of voids and low curing shrinkage.

| | | | Curing | |
|---|---|---|---|---|
| | CTE | Modulus | shrinkage | Voids |
| Bisoxazoline mixture (49%) + | 41 | 3.2 | 0.12% | No |
| Benzoxazine mixture (49%) + | | | | |
| MeOTs (2%) | | | | |

What is claimed:

1. A curable composition comprising an oxazoline and/or an oxazine and a cationic cure initiator, in the absence of any phenolic compounds.

2. The curable composition according to claim 1 in which the oxazoline and/or an oxazine compound is 1,3 bisoxazoline.

3. The curable composition according to claim 1 in which the cationic cure initiator is methyl-p-toluenesulfonate.

4. The curable composition according to claim 1 further comprising a filler.

5. The composition of claim 4, in which the inorganic filler is silica.

6. A device coated or molded with a curable composition according to claim 1, the curable composition cured.
